(19) United States
(12) Patent Application Publication
(10) Pub. No.: US 2026/0104957 A1
(43) Pub. Date: Apr. 16, 2026

(54) ERROR NOTIFICATION BROADCAST IN MULTI-CHIPLET PROCESSORS

(71) Applicant: ADVANCED MICRO DEVICES, INC., Santa Clara, CA (US)

(72) Inventors: Costas Argyrides, Austin, TX (US); WeiDong Jiang, Shanghai (CN); Kai Shao, Shanghai (CN)

(21) Appl. No.: 18/913,827

(22) Filed: Oct. 11, 2024

(51) Int. Cl. G06F 11/07

(52) U.S. Cl. CPC G06F 11/0784; G06F 11/0724; G06F 11/0772

(57) ABSTRACT

Systems and methods for providing low-latency broadcast of error notifications in multi-chiplet processors include an error handler circuits associated with parallel processing chiplets (PPCs) configured to broadcast an error notification inside and among the PPCs via dedicated communication lines when an error is detected in a memory associated with one of the PPCs. The error notification is simultaneously broadcast to each component of compute units in the PPCs, as well as chiplet interconnect circuits that provide for communication between the PPCs, using dedicated communication lines. As the error notification is quickly propagated to each component of a multi-chiplet processor, further errors are minimized and the processor can swiftly resume processing.

### BACKGROUND

Parallel processors such as accelerator processors and graphics processing units (GPUs) conventionally implement graphics processing pipelines that concurrently process copies of commands that are retrieved from a command buffer. GPUs and other multithreaded processing units typically implement multiple processing elements (which may include processor cores, compute units, chiplets, or workgroup processors) that execute different programs or concurrently execute multiple instances of a single program on multiple data sets as a single “wave,” i.e., a group of threads running concurrently on a GPU. A hierarchical execution model is typically used to match the hierarchy implemented in hardware.

The execution model defines a kernel of instructions that are executed by one or more waves (also referred to as wavefronts, which may include one or more threads, streams, tasks, or work items). The graphics pipeline in a conventional GPU includes one or more shader engines that execute computer programs typically referred to as “shaders” using resources of the graphics pipeline such as compute units, memory, and caches. GPUs are traditionally used for graphical calculations, as implied by their name; however, in modern computing, shaders are often utilized as “compute shaders,” which function as general-purpose software that is able to perform work separately from a graphics processing pipeline. As GPU usage and machine learning applications have expanded over time, there is a necessity to improve the functionality and performance of GPUs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing low-latency broadcast of error notifications in a multi-chiplet processor according to some implementations.

FIG. 2 is a block diagram illustrating an example of an error handler in a multi-chiplet processor providing low-latency broadcast of error notifications according to some implementations.

FIG. 3 is a flow diagram of a method of providing low-latency broadcast of error notifications in multi-chiplet processors according to some implementations.

### DETAILED DESCRIPTION

A parallel processor such as an accelerated processing device or graphics processing unit (GPU) typically includes a plurality of “shader engines,” where each shader engine includes a respective quantity of compute units, and a command processor coupled to the plurality of shader engines. The command processor receives one or more commands for execution and generates the plurality of workgroups or tasks (e.g., processing threads or collections of threads corresponding to one or more programs) based on the one or more commands. Assigning each workgroup to a respective shader engine may include dynamically assigning each workgroup to a respective shader engine via an interface such as a shader program interface (SPI), which acts as a scheduler, associated with the respective shader engine.

However, as GPU usage for executing compute shaders, machine learning applications, and other general-purpose applications has expanded over time, in order to provide a GPU with the flexibility to execute tasks related to a graphics processing pipeline, machine learning, or other advanced computing applications in an efficient manner, GPUs implemented in accordance with the teachings of the present disclosure include a plurality of parallel processing chiplets (PPCs), which are configured to process tasks and function as advanced GPU chiplets in that they offer one or more of parallel processing functionality, optimized GPU functionality, and optimized processing for advanced applications that utilize, e.g., reduced precision data common in machine learning. The PPCs are able to execute instructions separately or in parallel and, in some implementations, share a single pool of virtual and physical memory with extremely low latency. However, when errors are detected in memory due to, e.g., corrupted data, the process of distributing error notifications throughout a parallel processor can be inefficient and time consuming, potentially resulting in the production of further errors and significant delay from the time the error is detected to addressing the error and resuming processing. In particular, in conventional implementations, error notifications are typically propagated from component to component in a daisy chain or sequential fashion, which significantly limits the efficiency with which an error can be handled.

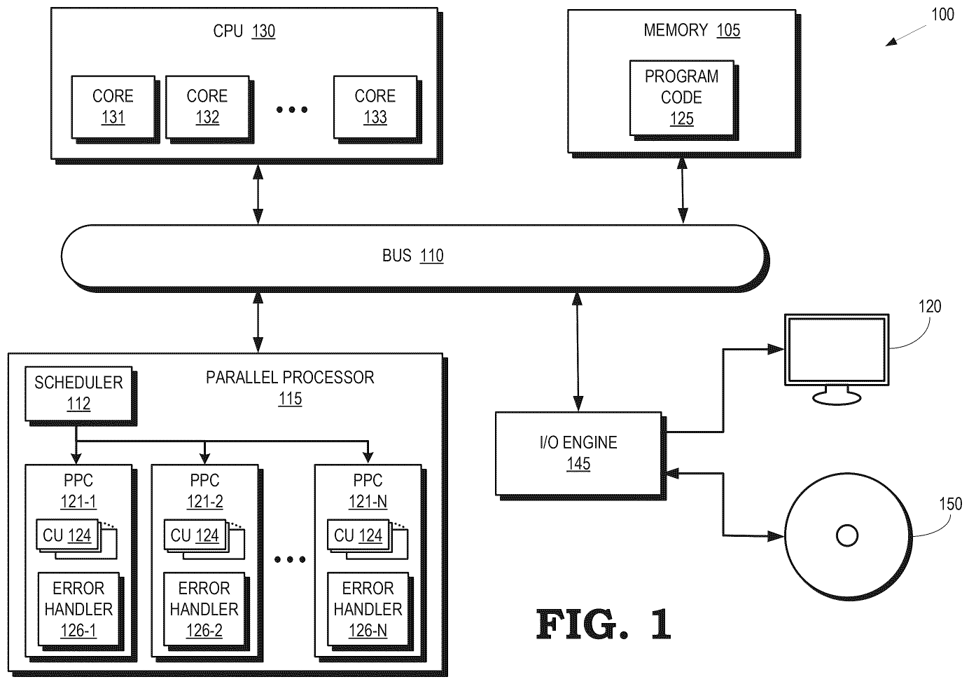

FIGS. 1-3 illustrate systems and techniques for providing low-latency broadcast of error notifications in multi-chiplet processors. In some implementations, as described in detail hereinbelow, an error handler circuit associated with each of the PPCs is configured to broadcast an error notification inside and among the PPCs via dedicated communication lines when an error is detected in a memory associated with one of the PPCs. By simultaneously broadcasting the error notification to each component of compute units in the PPCs as well as chiplet interconnect circuits that provide for communication between the PPCs using dedicated communication lines, the error notification is propagated as quickly as possible to each component of a multi-chiplet processor so that further errors are minimized and the processor is reset promptly, enabling the processor to swiftly resume processing. In some implementations, using such error handling circuits associated with each of the PPCs and dedicated communication lines for broadcasting error notifications reduces error notification time by as much as ten times, reducing a delay between error detection and action being taken to resolve the error from as much as 500 clock cycles down to as few as 50 clock cycles.

FIG. 1 is a block diagram of a processing system 100 providing low-latency broadcast of error notifications in a multi-chiplet processor according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a multi-chiplet processor, which is implemented in the illustrated example as parallel processor 115, in accordance with some implementations. In some implementations, the parallel processor 115 renders images for presentation on a display 120. For example, the parallel processor 115 renders objects to produce values of pixels that are provided to the display 120, which uses the pixel values to display an image that represents the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of PPCs, such as PPCs 121-1, 121-2, and 121-N, which are configured to process tasks and offer one or more of GPU functionality and optimized processing for advanced applications that utilize, e.g., reduced precision data common in machine learning. The PPCs 121 are able to execute instructions separately or in parallel and, in some implementations, share a single pool of virtual and physical memory with extremely low latency. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some implementations, the PPCs 121 are used to implement shaders, such as geometry shaders, pixel shaders, and the like. Generally, the PPCs 121 are a logical grouping of processing hardware, which in some implementations includes, e.g., one or more processing chiplets, cores, and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some implementations of the parallel processor 115 include more or fewer PPCs than are shown in FIG. 1.

In some implementations, the processing system 100 includes error handler circuits (EHCs) 126, such as EHCs 126-1, 126-2, and 126-N, that provide low-latency broadcast of error notifications in a multi-chiplet processor such as the parallel processor 115. The EHCs 126 are configured to receive an error notification from one of the compute units 124, a component of one of the compute units 124, or one of the PPCs 121 and broadcast the error notification to each of the other compute units 124 and/or PPCs 121, as appropriate. For example, if the EHC 126-1 of PPC 121-1 receives an error notification from one of the compute units 124 in the PPC 121-1, the EHC 126-1 immediately, e.g., within 1-10 clock cycles of receiving the error notification, broadcasts the error notification to each of the other compute units 124 in the PPC 121-1 as well as to all the other PPCs, such as the PPC 121-2 and the PPC 121-N. In response to receiving the error notification from the EHC 126-1, the EHC 126-2 in the PPC 121-2 then broadcasts the error notification to each of the compute units 124 in the PPC 121-2 and the EHC 126-N broadcasts the error notification to each of the compute units 124 in the PPC 121-N. Generally, when an error originates internal to a PPC 121, an error notification is communicated to the EHC 126, which then broadcasts the error notification to all other components of the associated PPC 121 and all other external PPCs 121. Similarly, when an error notification external to the associated PPC 121 is received by the EHC 126, the EHC 126 broadcasts the error notification inside the associated PPC 121 including individual components of compute units in the associated PPC 121.

In some implementations, the error notification is a notification of a fatal error in a memory associated with one of the compute units 124 or PPCs 121. For example, when an error correction code (ECC) or parity check for a memory associated with one of the compute units 124 or PPCs 121 results in a failure, indicating that corrupted data is present in the memory, the EHC 126 associated with the compute unit 124 or PPC 121 that generated the original error notification immediately broadcasts an error notification to the other compute units 124 and PPCs 121. In some implementations, when an error notification is received by any component of a PPC 121, further error notifications are suppressed in the PPC 121 until the parallel processor 115 is reset in order to avoid duplicative error notifications. In some implementations, the error notification causes each of the compute units 124 and PPCs 121 to halt further processing and causes the parallel processor 115 to reset all of its memories and caches, e.g., in response to an interrupt flag or other interrupt signal generated by the one of the EHCs 126. However, in some implementations, rather than resetting all of its memories and caches, each PPC 121 only resets affected memories and/or caches, or a subset of memories and caches, based on an analysis of the broadcasted error notifications. In some implementations, one or more of the EHCs 126, PPCs 121, the parallel processor 115, and/or the CPU 130 analyzes the broadcasted error notifications to identify affected memories and/or caches that should be reset. As the error notification is immediately broadcast inside and among the PPCs 121 and associated compute units 124, the amount of time required to halt processing and reset the parallel processor 115 is minimized, ensuring that further processing based on corrupted data is minimized and that processing can resume after the parallel processor 115 is reset with minimal delay.

As shown in FIG. 1, the parallel processor 115 further includes a scheduler 112, which is implemented as any cooperating collection of hardware, software, or a combination thereof that performs functions and computations associated with assigning threads, workgroups, waves, or other tasks, such as compute shader threads, to one or more of the PPCs 121. In some implementations, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121. In some implementations, the parallel processor 115 is used for general purpose computing. The parallel processor 115 executes instructions such as program code 125 stored in the memory 105 and the parallel processor 115 stores information in the memory 105 such as the results of the executed instructions.

In some implementations, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the parallel processor 115.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the parallel processor 115 or the CPU 130.

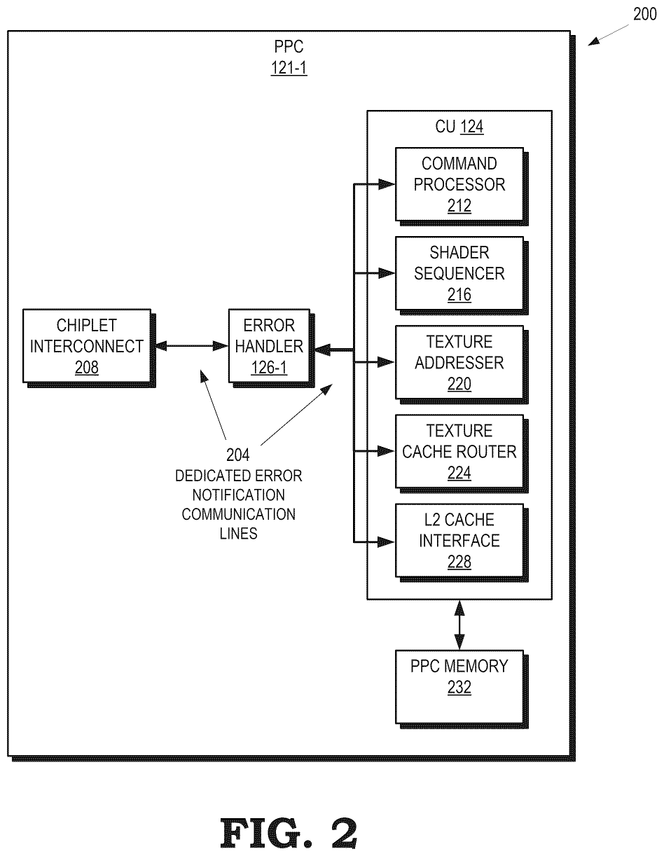

FIG. 2 is a block diagram 200 illustrating an example of an error handler circuit 126-1 in a multi-chiplet processor providing low-latency broadcast of error notifications according to some implementations. As shown in FIG. 2, the PPC 121-1 includes a number of dedicated error notification communication lines 204 between the EHC 126-1, individual components of the compute units 124, and a chiplet interconnect circuit 208. Although shown in FIG. 2 as individual two-way communication lines, in some implementations, each of the dedicated error notification communication lines 204 include separate transmit and receive lines for each component. In some implementations, the dedicated error notification communication lines 204 include one or more of wires, interconnects, and network-on-chip interfaces. In some implementations, the dedicated error notification communication lines 204 are common signal paths used for various purposes but remain dedicated in that when an error notification signal is driven onto the dedicated error notification communication lines 204, the error notification signal takes priority over and/or overrides any other signals present on the lines.

The chiplet interconnect circuit 208 provides for communication with each of the other PPCs, such as the PPC 121-2 and the PPC 121-N. The dedicated error notification communication lines 204 ensure that error notifications are quickly broadcast from the EHC 126-1 to the individual components of the compute units 124 and/or the other PPCs 121 whether the error notification originates internal or external to the PPC 121-1 associated with the EHC 126-1. For example, if an ECC or parity check in one of the other PPCs 121, such as PPC 121-2, results in a failure, causing a fatal error, an EHC 126 associated with that PPC 121, such as the EHC 126-2, broadcasts an error notification inside and among the PPCs 121, which the EHC 126-2 initiates by broadcasting the error notification a chiplet interconnect and components of the compute unit 124 inside the PPC 121-2 where the error originated. The chiplet interconnect in the PPC 121-2 then transmits the error notification to the other PPCs 121, such as the PPC 121-1, via the chiplet interconnect circuits associated with the other PPCs 121, such as the chiplet interconnect circuit 208. The chiplet interconnect circuit 208 then transmits the error notification to the EHC 126-1, which broadcasts the error notification to each of the components of the compute units 124 in the PPC 121-1.

For example, as shown in FIG. 2, in some implementations, each compute unit 124 (only one of which is illustrated in FIG. 2 for clarity) includes or is associated with a number of components such as a command processor 212, a shader sequencer 216, a texture addresser 220, a texture cache router 224, and/or an L2 cache interface 228, among others, some or all of which selectively utilizing a PPC memory 232. Generally, the command processor 212 manages and executes incoming instructions, the shader sequencer 216 schedules and dispatches shader threads, and the texture addresser 220 determines memory addresses for texture data needed by shader programs. The texture cache router 224 manages the flow of texture data between the texture cache and the command processor 212 and/or shader sequencer 216, and the L2 cache interface 228 serves as a bridge between the compute units 124 and an L2 cache associated with the PPC 121-1, which facilitates efficient data access and reduces memory latency by caching frequently accessed data.

Although the components in a compute unit 124 and their functionality vary in different implementations, the EHC 126-1 provides error notifications through the dedicated error notification communication lines 204 to each of the components of the compute unit 124 and/or to the chiplet interconnect circuit 208, as appropriate, when an error is detected in the PPC memory 232 associated with one of the components of one of the compute units 124. Broadcasting an error notification internal to an associated one of the PPCs 121 among the external PPCs 121 and inside the associated one of the PPCs 121 and/or broadcasting an error notification external to an associated one of the PPCs inside the associated one of the PPCs using dedicated error notification communication lines 204 minimizes an amount of time during which corrupted data results in further errors being produced and ensures that the parallel processor 115 is reset with minimal delay so the parallel processor 115 can begin processing tasks again as soon as possible.

In some implementations, if an error is detected in a portion of PPC memory 232 associated with the command processor 212 of a compute unit 124, for example, the command processor 212 immediately communicates an error notification to the EHC 126-1. After receiving the error notification from the command processor 212, the EHC 126-1 simultaneously broadcasts the error notification to each of the other components of the compute unit 124, such as the shader sequencer 216, the texture addresser 220, the texture cache router 224, and the L2 cache interface 228, as well as all of the components of all of the other compute units 124 within the PPC 121-1 via the dedicated error notification communication lines 204. At the same time, the EHC 126-1 broadcasts the error notification to the chiplet interconnect circuit 208, which transmits the error notification to each of the other PPCs 121, such as the PPC 121-2 and the PPC 121-N, and the compute units 124 and components of the compute units 124 within the other PPCs 121. In some implementations, the chiplet interconnect circuit 208 also broadcasts the error notification to the scheduler 112, the parallel processor 115, and/or the CPU 130. In some implementations, after each component of each compute unit 124 and each of the PPCs 121 receives the error notification, generation of further error notifications is suppressed until the parallel processor 115 is reset in order to avoid duplicative error notifications. For example, when the PPCs 121, the compute units 124, individual components of the compute units 124, the scheduler 112, the parallel processor 115, and/or the CPU 130 receive an error notification from any source, further processing and error reporting will be halted at each of the components that receive the error notification. In some implementations, each of the components that receive the error notification set a flag in a memory, such as memory 105, that prevents the components from producing any further error notifications. In some implementations, each of the components that receive the error notification halts further processing, which prevents any further error notifications from being produced.

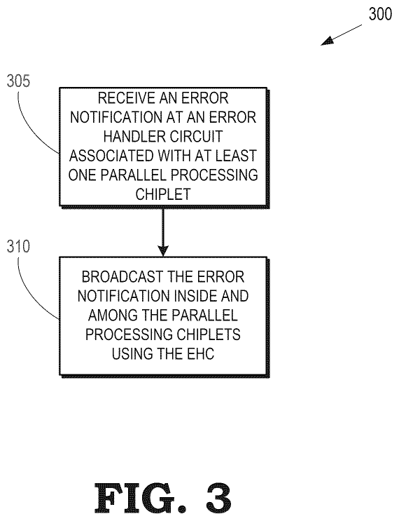

FIG. 3 is a flow diagram of a method 300 of handling errors in a multi-chiplet processor such as the parallel processor 115 of FIG. 1 including a plurality of PPCs 121 to provide low-latency broadcast of error notifications according to some implementations. In some implementations, the method 300 is executed by an EHC 126, such as one of the EHC 126-1, the EHC 126-2, and the EHC 126-N, of FIG. 1. At block 305 of the method 300, the EHC 126 associated with at least one of the PPCs 121 receives an error notification, such as a notification of a fatal error in the PPC memory 232. At block 310 of the method 300, the EHC 126 broadcasts the error notification inside and among the PPCs 121.

In some implementations, as described further hereinabove, the EHC 126 broadcasts the error notification to a chiplet interconnect circuit, such as the chiplet interconnect circuit 208 of FIG. 2, and the chiplet interconnect circuit broadcasts the error notification among the PPCs 121. In some implementations, the EHC 126 broadcasts the error notification to compute units 124 and/or individual components of compute units 124 in the PPCs 121, such as one or more of a command processor, a shader sequencer, a texture addresser, a texture cache router, and an L2 cache interface. In some implementations, the multi-chiplet processor or components thereof, such as one or more of the PPCs 121, the compute units 124, individual components of the compute units 124, and/or the scheduler 112, suppress generation of further error notifications in response to the broadcasted error notification. In some implementations, the EHC 126 uses dedicated communication lines, such as the dedicated error notification lines 204, between the EHC 126, individual components of compute units 124 in the PPCs 121, and chiplet interconnect circuits 208 in the PPCs 121 to broadcast the error notification. In some implementations, the multi-chiplet processor is reset in response to the error notification, clearing all or a portion of the memory and caches in the processor to eliminate any corrupted data so that the processor can resume processing tasks. For example, in some implementations, the parallel processor 115 resets itself in response to receiving an error notification, while in other implementations the CPU 130 resets the parallel processor 115 in response to receiving an error notification from the parallel processor 115.

In some implementations, the apparatuses and techniques described above are implemented in a system including one or more integrated circuit (IC) devices (also referred to as integrated circuit packages or microchips), such as the parallel processor 115, the PPCs 121, the scheduler 112, the compute units 124, the EHCs 126, and the method 300 described above. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

1. An apparatus comprising:
a multi-chiplet processor comprising:
a plurality of parallel processing chiplets (PPCs) comprising compute units configured to process tasks; and
an error handler circuit (EHC) associated with each of the PPCs configured to broadcast an error notification inside and among the PPCs.

2. The apparatus of claim 1, wherein the multi-chiplet processor further comprises a chiplet interconnect circuit configured to provide communication between the plurality of PPCs, wherein the EHC is configured to broadcast the error notification to the chiplet interconnect circuit, and the chiplet interconnect circuit is configured to broadcast the error notification among the PPCs.

3. The apparatus of claim 1, wherein the EHC is configured to broadcast the error notification to the compute units in the PPCs.

4. The apparatus of claim 3, wherein the EHC is configured to broadcast the error notification to individual components of the compute units.

5. The apparatus of claim 4, wherein the individual components of the compute units include one or more of a command processor, a shader sequencer, or a texture addresser.

6. The apparatus of claim 4, wherein the individual components of the compute units are configured to suppress generation of further error notifications in response to the broadcasted error notification.

7. The apparatus of claim 1, wherein the multi-chiplet processor or one or more of the PPCs are configured to reset one or more memories or caches in response to the error notification.

8. The apparatus of claim 1, wherein the error notification is a notification of a fatal error in a memory associated with one of the PPCs.

9. The apparatus of claim 1, wherein each of the PPCs comprises dedicated communication lines between the EHC, individual components of compute units in the PPCs, and a chiplet interconnect circuit in the PPCs.

10. A method of handling errors in a multi-chiplet processor including a plurality of parallel processing chiplets (PPCs), comprising:
receiving an error notification at an error handler circuit (EHC) associated with at least one of the PPCs; and
broadcasting the error notification inside and among the PPCs using the EHC.

11. The method of claim 10, further comprising broadcasting the error notification to a chiplet interconnect circuit using the EHC, wherein the chiplet interconnect circuit broadcasts the error notification among the PPCs.

12. The method of claim 10, further comprising using the EHC to broadcast the error notification to compute units in the PPCs.

13. The method of claim 12, further comprising using the EHC to broadcast the error notification to individual components of the compute units.

14. The method of claim 13, wherein the individual components of the compute units include one or more of a command processor, a shader sequencer, or a texture addresser.

15. The method of claim 13, further comprising suppressing generation of further error notifications in response to the broadcasted error notification.

16. The method of claim 10, wherein broadcasting the error notification uses dedicated communication lines between the EHC, individual components of compute units in the PPCs, and a chiplet interconnect circuit in the PPCs.

17. The method of claim 10, further comprising resetting the multi-chiplet processor in response to the error notification.

18. A system comprising:
a multi-chiplet processor comprising:
a plurality of parallel processing chiplets (PPCs) configured to process tasks, each of the PPCs including an associated error handler circuit (EHC) configured to receive an error notification internal to an associated one of the PPCs and to broadcast the error notification among the PPCs.

19. The system of claim 18, wherein the EHC is configured to receive an error notification external to the associated one of the PPCs and to broadcast the error notification inside the associated one of the PPCs.

20. The system of claim 19, wherein the EHC broadcasts the received error notification external to the associated one of the PPCs to individual components of compute units in the associated one of the PPCs.
